(19) United States
(12) Patent Application Publication
(10) Pub. No.: US 2010/0003973 A1
(43) Pub. Date: Jan. 7, 2010

(54) Radio Communication Method and Radio Communication Terminal

(75) Inventors: Susumu Kashiwase, Kanagawa (JP); Kugo Morita, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/375,397

(22) PCT Filed: Jul. 27, 2007
(86) PCT No.: PCT/JP2007/064770

§ 371 Date: Sep. 9, 2009

(30) Foreign Application Priority Data
Jul. 28, 2006 (JP) 2006-207237

(51) Int. Cl. H04W 4/00; H04B 1/04

(52) U.S. Cl. 455/422.1; 455/127.1

(57) ABSTRACT

A gist of the present invention is a radio communication method including the steps of calculating a transmission power difference between transmission power of a first carrier and transmission power of a second carrier, determining whether or not the transmission power difference exceeds a threshold that is set up on the basis of a maximum transmission power difference allowable between the first carrier and the second carrier, and disconnecting any one carrier out of the first carrier and the second carrier when the transmission power difference exceeds the threshold set up on the basis of the maximum transmission power difference.

### TECHNICAL FIELD

The present invention relates to a radio communication method in reverse link by multicarrier using multiple carriers, and also to a radio communication terminal for performing communications by multicarrier.

### BACKGROUND ART

In recent years, as applications, such as moving images or games, to be handled have been diversified and sophisticated, the data transmission rate in a mobile communication system has been strongly demanded to be speeded up. With such a background, the Third Generation Partnership Project 2 (3GPP2), for example, defines a scheme for implementing high speed data transmissions by using multiple carriers bundled in an upper layer (so-called multicarrier).

In the case of multicarrier, a radio communication terminal (Access Terminal) generally employs a configuration in which multiple carriers are transmitted by use of a single radio communication network, in view of downsizing, reduction in manufacturing cost or the like. Thus, in order to reduce interference between adjacent carriers that are adjacent to each other with a predetermined frequency interval (1.25 MHz interval), it is provided that a transmission power difference between adjacent carriers should be within a predetermined threshold (MaxRLTxPwrDiff, 15 dB, for example) (Non-patent document 1, for example).
Non-patent document 1 “cdma2000 High Rate Packet Data Air Interface 3GPP2 C.S0024-B Version 1.0”, 3GPP2, June 2006

### DISCLOSURE OF THE INVENTION

As described above, 3GPP2 provides that a transmission power difference between adjacent carriers be controlled to be within a predetermined threshold (MaxRLTxPwrDiff). In some cases, however, the transmission power difference cannot be maintained within the predetermined threshold under some communication conditions between a radio communication terminal and a radio base station (Access Network).

For example, when a radio communication terminal moves away from a first radio base station that is currently performing communications by use of a first carrier and simultaneously moves toward a second radio base station that is currently performing communications by use of a second carrier adjacent to the first carrier with a predetermined frequency interval, the radio communication terminal needs to increase the transmission power of the first carrier to maintain communications with the first radio base station using the first carrier. In addition, as the radio communication terminal comes closer to the second radio base station, it reduces the transmission power of the second carrier.

In this way, in some cases, the radio communication terminal may not be able to maintain the transmission power difference within the predetermined threshold to continue communications currently being performed with the first radio base station and the second radio base station.

Hence, the present invention has been made in light of such the circumstances, and it is an object of the present invention to provide a radio communication method and a radio communication terminal that are capable of maintaining communications by multicarrier, while preventing interference between adjacent carriers which are adjacent to each other with a predetermined frequency interval.

An aspect of the present invention provides a radio communication method in reverse link by multicarrier using at least a first carrier and a second carrier that is adjacent to the first carrier with a predetermined frequency interval. The radio communication method includes the steps of calculating a transmission power difference between the first carrier and the second carrier, determining whether or not the transmission power difference exceeds a threshold that is set up on the basis of a maximum transmission power difference allowable between the first carrier and the second carrier, and disconnecting any one carrier out of the first carrier and the second carrier when the transmission power difference exceeds the threshold set up on the basis of the maximum transmission power difference.

According to this aspect, if the transmission power difference exceeds the threshold which is set up on the basis of the maximum transmission power difference, any one carrier out of the first carrier and the second carrier is disconnected. Thereby, the transmission power difference can be prevented from exceeding the maximum transmission power difference.

That is, it is possible to continue the communications by multicarrier while suppressing interference between the adjacent carriers which are adjacent to each other with the predetermined frequency interval.

Another aspect of the present invention is, in the above-mentioned aspect of the present invention, the radio communication method further including the step of transmitting a connection request for requesting connection of a new carrier to a radio base station capable of communications after disconnecting any one carrier out of the first carrier and the second carrier.

Another aspect of the present invention is, in the above-mentioned aspect of the present invention, the radio communication method further including the step of determining whether or not a retention amount of data to be transmitted exceeds an allowable retention amount defined to be not more than a maximum allowable retention amount of the data after disconnecting any one carrier out of the first carrier and the second carrier. In the step of transmitting the connection request, the connection request is transmitted when the retention amount of the data to be transmitted exceeds the allowable retention amount.

Another aspect of the present invention is that, in the above-mentioned aspect of the present invention, the connection request is transmitted while excluding a radio base station, which has been connected via the carrier having been disconnected, from the radio base station capable of communications in the step of transmitting the connection request.

Another aspect of the present invention is that, in the above-mentioned aspect of the present invention, the transmission power difference is calculated in a predetermined cycle in the step of calculating the transmission power difference, that the radio communication method further includes the step of determining whether or not the transmission power difference has increased on the basis of the transmission power difference calculated in the predetermined cycle, and that, in the step of disconnecting the carrier, any one carrier out of the first carrier and the second carrier is disconnected when the transmission power difference is determined to have increased.

Another aspect of the present invention provides a radio communication terminal configured to perform communications by multicarrier using at least a first carrier and a second carrier that is adjacent to the first carrier with a predetermined frequency interval. The radio communication terminal includes a transmission power difference calculator (a transmission power difference calculator 22) configured to calculate a transmission power difference between the first carrier and the second carrier, a transmission power difference determining unit (a transmission power difference calculator 22) configured to determine whether or not the transmission power difference calculated by the transmission power difference calculator exceeds a threshold that is set up on the basis of a maximum transmission power difference allowable between the first carrier and the second carrier, and a communication controller (a communication controller 23) configured to disconnect any one carrier out of the first carrier and the second carrier when the transmission power difference determining unit determines that the transmission power difference exceeds the threshold set up on the basis of the maximum transmission power difference.

Another aspect of the present invention is, in the above-mentioned aspect of the present invention, the radio communication terminal further including a connection request transmitter (the communication controller 23) configured to transmit a connection request for requesting connection of a new carrier to a radio base station capable of communications after any one carrier out of the first carrier and the second carrier is disconnected by the communication controller.

Another aspect of the present invention is, in the above-mentioned aspect of the present invention, the radio communication terminal further including a transmission data buffer (a transmission data buffer 24) configured to accumulate data to be transmitted and a data retention amount determining unit (the communication controller 23) configured to determine whether or not a retention amount of the data in the transmission data buffer exceeds an allowable retention amount defined to be not more than a maximum allowable retention amount after any one carrier out of the first carrier and the second carrier is disconnected by the communication controller. In the radio communication terminal, the connection request transmitter transmits the connection request when the data retention amount determining unit determines that the retention amount of the data exceeds the allowable retention amount.

Another aspect of the present invention is that, in the above-mentioned aspect of the present invention, the connection request transmitter transmits the connection request while excluding a radio base station, which has been connected via the carrier having been disconnected, from the radio base station capable of communications.

Another aspect of the present invention is that, in the above-mentioned aspect of the present invention, the transmission power difference calculator calculates the transmission power difference in a predetermined cycle, that the radio communication terminal further includes a power difference determining unit (a transmission power difference determining unit 25) configured to determine whether or not the transmission power difference has increased on the basis of the transmission power difference calculated in the predetermined cycle by the transmission power difference calculator, and that the communication controller disconnects any one carrier out of the first carrier and the second carrier when the power difference determining unit determines that the transmission power difference has increased.

According to the characteristics of the present invention, it is possible to provide a radio communication method and a radio communication terminal that can maintain communications by multicarrier while interference between adjacent carriers that are adjacent to each other with a predetermined frequency interval is controlled.

### BRIEF DESCRIPTION OF THE DRAWINGS

FIG. 1 is a view showing an overall schematic configuration of a communication system 300 according to a first embodiment of the present embodiment.

FIG. 2 is a view showing frequency bandwidth in reverse link according to the first embodiment of the present invention.

FIG. 3 is a block configuration diagram of a radio communication terminal 10 according to the first embodiment of the present invention.

FIG. 4 is a view showing one example of a table stored in a memory 19 according to the first embodiment of the present invention.

FIG. 5 is a functional block diagram of a controller 20 according to the first embodiment of the present invention.

FIG. 6 is a flowchart showing operation of the radio communication terminal 10 according to the first embodiment of the present invention (Pattern 1).

FIG. 7 is a flowchart showing the operation of the radio communication terminal 10 according to the first embodiment of the present invention (Pattern 2).

FIG. 8 is a flowchart showing the operation of the radio communication terminal 10 according to the first embodiment of the present invention (Pattern 3).

FIG. 9 is a flowchart showing the operation of the radio communication terminal 10 according to the first embodiment of the present invention (Pattern 4).

FIG. 10 is a functional block configuration diagram of a controller 20 according to a second embodiment of the present invention.

FIG. 11 is a flowchart showing the operation of a radio communication terminal 10 according to the second embodiment of the present invention.

FIG. 12 is a functional block configuration diagram of a controller 20 according to a third embodiment of the present invention.

FIG. 13 is a graph for explaining calculation of an estimated curve difference (a difference of values calculated by estimated curve expressions of carriers) according to the third embodiment of the present invention.

FIG. 14 is a flowchart showing the operation of a radio communication terminal 10 according to the third embodiment of the present invention.

### BEST MODES FOR CARRYING OUT THE INVENTION

Next, embodiments of the present invention will be described. In the following description of the drawings, a same or similar reference numeral is given to a same or similar part. However, it should be noted that the drawings are schematic and the ratio of each dimension differs from actual ratio.

Thus, specific dimensions and the like are to be determined by referring to the following description. In addition, a relationship or a ratio of mutual dimensions may differ among the drawings, as a matter of course.

### First Embodiment

(Overall Schematic Configuration of Communication System)

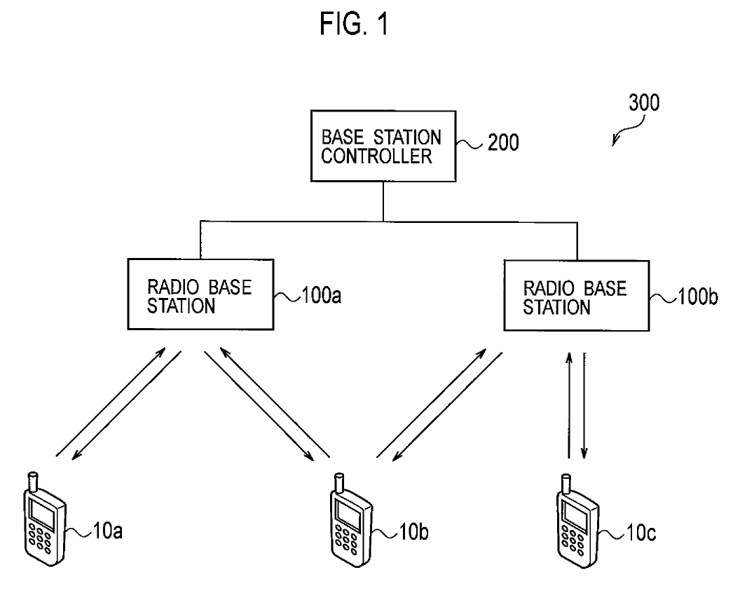

An overall schematic configuration of a communication system according to a first embodiment of the present embodiment will be described hereinafter with reference to the drawings. FIG. 1 shows an overall schematic configuration of a communication system 300 according to the first embodiment of the present embodiment.

As shown in FIG. 1, the communication system 300 includes multiple radio communication terminals 10 (a radio communication terminal 10a to a radio communication terminal 10c), multiple radio base stations 100 (a radio base station 100a and a radio base station 100b), and a base station controller 200.

Each of the radio communication terminals 10 transmits reverse link data to each of the radio base stations 100 by using a reverse link frequency band assigned for transmitting the reverse link data. Specifically, the reverse link frequency band is divided into multiple carriers. Then, the radio communication terminal 10 transmits the reverse link data to the base radio base station 100 by using the multiple carriers bundled in an upper layer (multicarrier).

In addition, the radio communication terminal 10 receives forward link data from the radio base station 100 by using a forward link frequency band assigned for transmitting the forward link data. Specifically, the forward link frequency band is divided into multiple carriers. Then, the radio communication terminal 10 receives the forward link data from the radio base station 100 by using the multiple carriers bundled in an upper layer (multicarrier).

Note that the radio communication terminal 10, as in the case of the radio communication terminal 10a or the radio communication terminal 10c, may communicate with a single radio base station 100. In addition, the radio communication terminal 10 may communicate with multiple radio base stations 100, as in the case of the radio communication terminal 10b.

The radio base station 100 receives the reverse link data from the radio communication terminal 10 by using the reverse link frequency band assigned for transmitting the reverse link data. The radio base station 100 also transmits the forward link data to the radio communication terminals 10 by using the forward link frequency band assigned for transmitting the forward link data.

The base station controller 200 controls communications made between the radio communication terminals 10 and the radio base stations 100. The base station controller 200 performs operations such as handoff in which the radio communication terminal 10 switches one radio base station 100 for communicating therewith to the other.

In the communication system 300, the radio communication terminal 10 performs open loop control in which transmission power of reverse link data is controlled on the basis of received power of forward link data received from the radio base station 100. The radio communication terminal 10 also performs closed loop control in which transmission power of reverse link data is controlled on the basis of power control information received from the radio base station 100. The power control information herein is information that the radio base station 100 generates on the basis of reception quality (for example, signal to interference ratio (SIR)) of the reverse link data received from the radio communication terminal 10.

(Reverse Link Frequency Band)

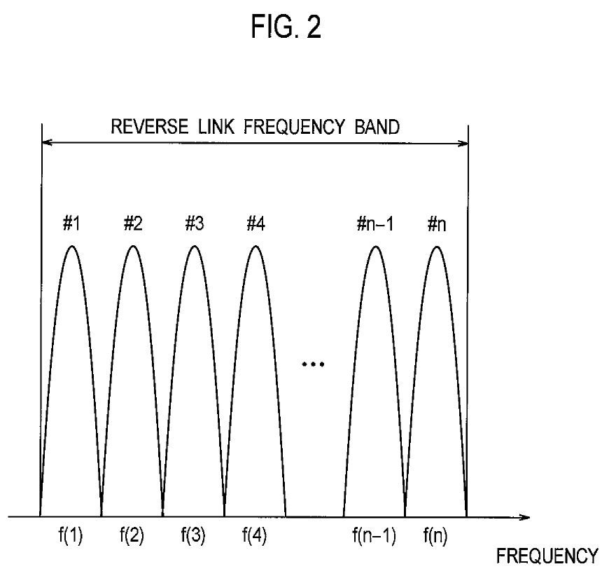

A reverse link frequency band according to the first embodiment of the present invention will be described hereinafter with reference to the drawings. FIG. 2 shows the reverse link frequency band according to the first embodiment of the present invention.

As shown in FIG. 2, the reverse link frequency band is divided into multiple carriers (carrier #1 to carrier #n). In addition, center frequencies of the carriers are f(1) to f(n), respectively. The center frequencies of the carriers are adjacent to each other being spaced apart at a predetermined frequency interval (e.g., 1.25 MHz). Two carriers having their center frequencies being adjacent to each other will be hereinafter referred to as adjacent carriers.

(Configuration of Radio Communication Terminal)

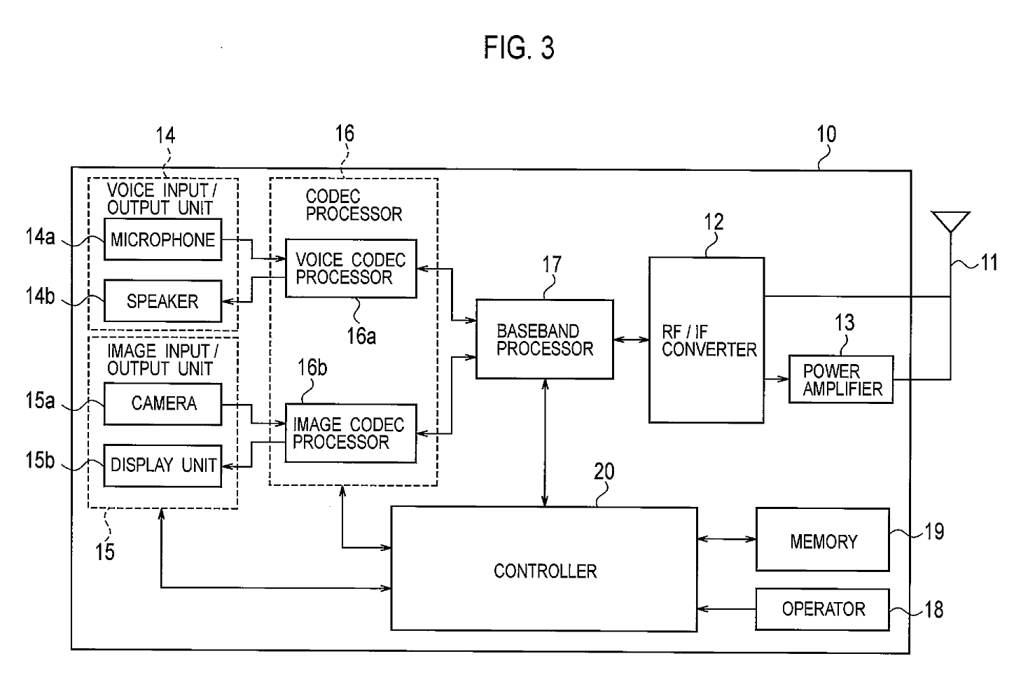

A configuration of the radio communication terminal according to the first embodiment of the present invention will be described hereinafter with reference to the drawings. FIG. 3 is a functional block configuration diagram showing the radio communication terminal 10 according to the first embodiment of the present invention. Since the radio communication terminals 10a to 10c have similar configurations, they will be collectively referred to as a radio communication terminal 10 in the following description.

As shown in FIG. 3, the radio communication terminal 10 includes an antenna 11, an RE/IF converter 12, a power amplifier 13, a voice input/output unit 14, an image input output unit 15, a codec processor 16, a base band processor 17, an operator 18, a memory 19, and a controller 20.

The antenna 11 receives a signal (a reception signal) transmitted by the radio base stations 100. The antenna 11 also transmits a signal (a transmission signal) to the radio base station 100.

The RF/IF converter 12 converts a frequency (Radio Frequency (RF)) of a reception signal received by the antenna 11 into a frequency (Intermediate Frequency (IF)) to be handled by the baseband processor 17. The RF/IF converter 12 also converts the frequency (IF) of a transmission signal acquired from the baseband processor 17 into the frequency (RF) to be used in radio communications. In addition, the RF/IF converter 12 inputs the transmission signal converted into the radio frequency (RF) to the power amplifier 13.

The power amplifier 13 amplifies the transmission signal acquired from the RF/IF converter 12. The amplified transmission signal is inputted to the antenna 11.

The voice input/output unit 14 has a microphone 14a for collecting voice and a speaker 14b for outputting voice. The microphone 14a inputs a voice signal into the codec processor 16 on the basis of the collected voice. The speaker 14b outputs voice on the basis of the voice signal acquired from the codec processor 16.

The image input/output unit 15 includes a camera 15a for capturing an object, and a display unit 15b for displaying characters, images, and the like. The camera 15a inputs an image signal to the codec processor 16 on the basis of captured images (still images and moving images). The display unit 15b displays images on the basis of the image signal acquired from the codec processor 16. The display unit 15b also displays characters to be inputted through the operator 18.

The codec processor 16 includes: a voice codec processor 16a for encoding and decoding a voice signal according to a predetermined encoding scheme (EVRC (Enhanced Variable Rate Codec), AMR (Advanced Multi Rate Codec) or G.729 compliant with ITU-T, for example); and an image codec processor 16b for encoding and decoding an image signal according to a predetermined encoding scheme (MPEG-4, for example).

The voice codec processor 16a encodes a voice signal acquired from the voice input/output unit 14. The voice codec processor 16a also decodes a voice signal acquired from the baseband processor 17. The image codec processor 16b encodes an image signal acquired from the image input/output unit 15. The image codec processor 16b also decodes an image signal acquired from the baseband processor 17.

The baseband processor 17 modulates a transmission signal or demodulates a reception signal according to a predetermined modulation scheme (QPSK or 16QAM) or the like. Specifically, the baseband processor 17 modulates a baseband signal such as a voice signal or an image signal acquired from the codec processor 16. The modulated baseband signal (transmission signal) is inputted into the RF/IF converter 12. The baseband processor 17 also demodulates a reception signal acquired from the RF/IF converter 12. The demodulated reception signal (baseband signal) is inputted into the codec processor 16.

The baseband processor 17 modulates information generated by the controller 20. The modulated information (transmission signal) is inputted into the RF/IF converter 12. The baseband processor 17 also demodulates a reception signal acquired from the RF/IF converter 12. The demodulated reception signal is inputted into the controller 20.

The operator 18 is a group of keys formed of input keys for allowing characters, digits, and the like to be inputted, a response key for responding to incoming calls (calling), a calling key for outgoing calls (originating call), and the like. In addition, when each key is pressed, the operator 18 allows an input signal corresponding to the pressed key to be inputted to the controller 20.

The memory 19 stores therein a program for controlling operation of the radio communication terminal 10, various types of data such as incoming and outgoing call history, an address book, and the like. The memory 19 is formed of, for example, a flash memory that is a nonvolatile semiconductor memory, or a SRAM (Static Random Access Memory) that is a volatile semiconductor memory, or the like.

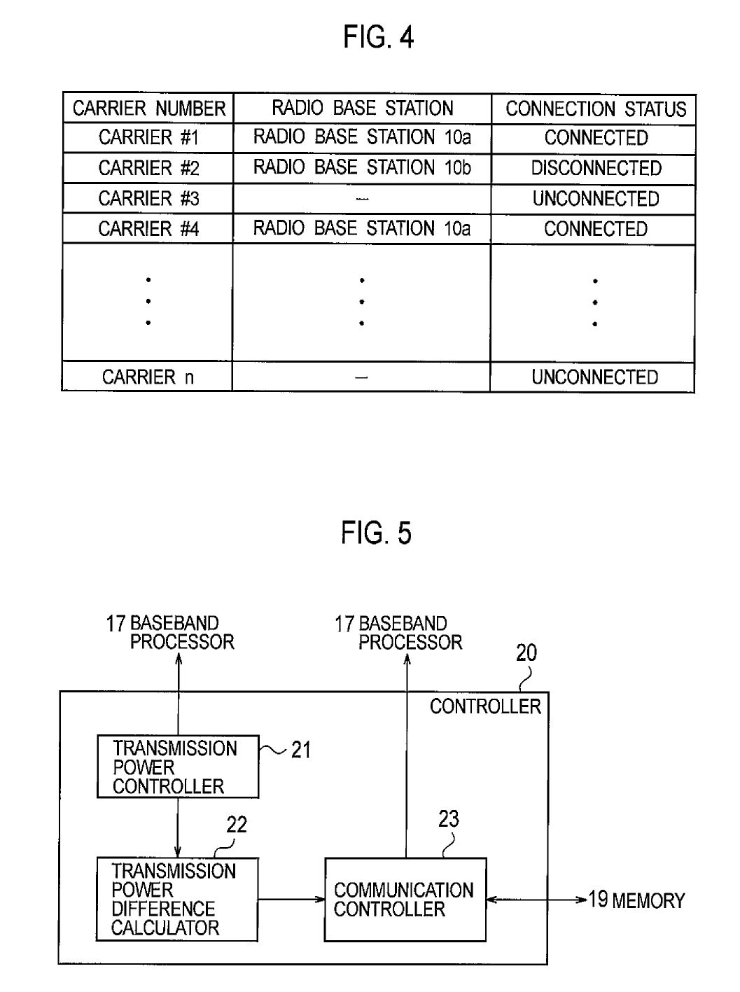

Here, as shown in FIG. 4, the memory 19 includes a table associating a carrier number with a radio base station and a connection status.

Numbers allocated to the carriers for identifying the carriers each other are stored in the “carrier number” column.

Information (such as names) for identifying the radio base stations connected to the radio communication terminals 10 via the carriers is stored in the “radio base station” column. Here, the combinations of the carrier numbers and the radio base stations are not fixed but are changed in response to reception quality of the forward link data and the like.

Information (“connected”, “disconnected”, and “unconnected”) indicating the connection status of each carrier is stored in the “connection status” column. The “connected” indicates that the radio base station 100 in the “radio base station” column is connected to the radio communication terminal 10 via the carrier in the “carrier number” column. The “disconnected” indicates that the carrier in the “carrier number” column is disconnected. The “unconnected” indicates that the carrier in the “carrier number” column is not connected yet. Here, after an elapse of a predetermined period after disconnection of the carrier in the “carrier number” column, the information in the “connection status” column is rewritten from the “disconnected” to the “unconnected”.

The controller 20 controls the operations of the radio communication terminal 10 (the image input/output unit 15, the codec processor 16, the baseband processor 17, and so forth) in accordance with the program stored in the memory 19.

Now, a configuration of the controller according to the first embodiment of the present invention will be described below with reference to the accompanying drawings. FIG. 5 is a functional block diagram showing the controller 20 according to the first embodiment of the present invention.

As shown in FIG. 5, the controller 20 includes a transmission power controller 21, a transmission power difference calculator 22, and a communication controller 23.

The transmission power controller 21 controls transmission power of reverse link data for each carrier. Specifically, the transmission power controller 21 controls the transmission power of the reverse link data on the basis of reception quality (SIR, for example) of forward link data received from the radio base station 100 to which reverse link data is transmitted (open loop control).

The transmission power controller 21 also controls transmission power of reverse link data on the basis of power control information received from the radio base stations 100 to which reverse link data is transmitted (closed loop control). As described above, the power control information is information that the radio base station 100 generates on the basis of reception quality (SIR, for example) of the reverse link data. The power control information requests for a decrease or an increase in the transmission power of the reverse link data.

The transmission power difference calculator 22 calculates a transmission power difference of reverse link data (hereinafter referred to as a transmission power difference) between adjacent carriers. In addition, the transmission power difference calculator 22 determines whether or not the transmission power difference between the adjacent carriers exceeds a maximum transmission power difference (MaxRLTxPwrDiff) to be allowed between the adjacent carriers. When the transmission power difference between the adjacent carriers exceeds a threshold that is set up on the basis of the maximum transmission power difference, the transmission power difference calculator 22 informs the communication controller 23 of the fact that the transmission power difference between the adjacent carriers has exceeded the threshold set up on the basis of the maximum transmission power difference.

Here, the threshold to be set up on the basis of the maximum transmission power difference may be equal to the maximum transmission power difference or may be a value smaller than the maximum transmission power difference (such as a value obtained by multiplying the maximum transmission power difference by a predetermined ratio (0.9)).

When the fact that the transmission power difference between the adjacent carriers exceeds the threshold set up on the basis of the maximum transmission power difference is informed, the communication controller 23 disconnects any one carrier out of the adjacent carriers.

Here, the disconnection of the carrier means interruption of transmission on the carrier. Meanwhile, the disconnection of the carrier is a concept including a cutoff of a connection on a physical layer by transmitting a carrier disconnection request (such as “Connection Close Message”) to the radio base station 100. Specifically, the disconnection of the carrier is the concept including the interruption of the transmission on the carrier as a result of the interruption of the transmission of the reverse link data using the carrier due to the cutoff of the connection on the physical layer.

Here, it is to be noted that the communications performed between the radio communication terminal 10 and the radio base station 100 will be maintained even if the carrier is disconnected, provided that another carrier is connected thereto.

Meanwhile, when any one carrier out of the adjacent carriers is disconnected due to the fact that the transmission power difference between the adjacent carriers exceeds the threshold set up on the basis of the maximum transmission power difference, the communication controller 23 selects the radio base station 100 to be connected to the radio communication terminal 10 out of the radio base stations 100 located around the radio communication terminal 10, and selects the carrier to be used for the transmission of the reverse link data. Subsequently, the communication controller 23 transmits a connection request for the carrier to be used for the transmission of the reverse link data to the radio base station 100 to be connected to the radio communication terminal 10.

Specifically, the communication controller 23 measures reception quality (SIR, for example) of the forward link data which is transmitted by the radio base stations 100 located around the radio communication terminal 10. Based on the measured reception quality, the communication controller 23 selects the radio base station 100 to be connected to the radio communication terminal 10. For example, the communication controller 23 selects the radio base station 100 that has transmitted the forward link data having the best reception quality as the radio base station 100 to be connected to the radio communication terminal 10.

Here, the communication controller 23 refers to the table stored in the memory 19 and excludes the radio base station 100 the “connection status” column of which is marked as “disconnected” from the radio base station 100 to be connected to the radio communication terminal 10.

Subsequently, the communication controller 23 refers to the table stored in the memory 19 and selects the carrier to be used for transmission of the reverse link data out of the carriers the “connection status” columns of which are marked either as “unused” or “disconnected”. For example, the radio communication terminal 10 selects the carrier having the central frequency that is the farthest from the central frequency of the carrier thereof from the carriers the “connection status” columns of which are marked as “connected”.

(Operation of Radio Communication Terminal)

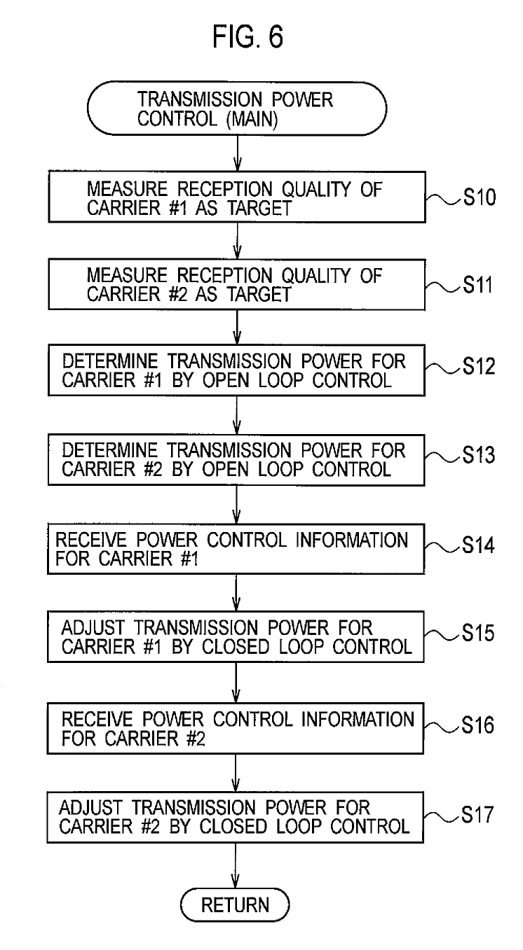

The operation of the radio communication terminal according to the first embodiment of the present invention will be described below with reference to the drawings. FIG. 6 to FIG. 9 are flowcharts of the operation of the radio communication terminal 10 according to the first embodiment of the present invention.

In the following, a case where the adjacent carriers include a carrier #1 and a carrier #2 will be described as an example. In addition, the radio communication terminal 10 is assumed to transmit reverse link data to the radio base station 100a by using the carrier #1 and to transmit reverse link data to the radio base station 100b by using the carrier #2.

First, main processing of controlling transmission power will be described with reference to FIG. 6. Note that, the main processing of controlling the transmission power is repeatedly performed in a predetermined cycle.

As shown in FIG. 6, in step 10, the radio communication terminal 10 measures reception quality of forward link data targeting the carrier #1. Specifically, the radio communication terminal 10 measures the reception quality of the forward link data received from the radio base station 100a to which the radio communication terminal 10 transmits the reverse link data by using the carrier #1.

In step 11, the radio communication terminal 10 measures reception quality of forward link data targeting the carrier #2. Specifically, the radio communication terminal 10 measures the reception quality of the forward link data received from the radio base station 100b to which the radio communication terminal 10 transmits the reverse link data by using the carrier #2.

In step 12, the radio communication terminal 10 determines transmission power of the reverse link data to be transmitted by using the carrier #1 through the open loop control. Specifically, the radio communication terminal 10 determines the transmission power of the reverse link data to be transmitted by using the carrier #1 on the basis of the reception quality measured in step 10.

In step 13, the radio communication terminal 10 determines transmission power of the reverse link data to be transmitted by using the carrier #2 through the open loop control. Specifically, the radio communication terminal 10 determines the transmission power of the reverse link data to be transmitted by using the carrier #2 on the basis of the reception quality measured in step 11.

In step 14, the radio communication terminal 10 receives power control information for the carrier #1. Specifically, the radio communication terminal 10 receives the power control information from the radio base station 100a to which the radio communication terminal 10 transmits the reverse link data by using the carrier #1. Here, the power control information is the information generated by the radio base station 100a on the basis of the reception quality of the reverse link data to be transmitted by using the carrier #1.

In step 15, the radio communication terminal 10 adjusts the transmission power of the reverse link data to be transmitted by using the carrier #1 through the closed loop control. Specifically, the radio communication terminal 10 adjusts the transmission power of the reverse link data determined in step 12 on the basis of the power control information received in step 14.

That is, the radio communication terminal 10 transmits the reverse link data by using the carrier #1 at the transmission power determined by the open loop control and the closed loop control.

In step 16, the radio communication terminal 10 receives power control information for the carrier #2. Specifically, the radio communication terminal 10 receives the power control information from the radio base station 100b to which the radio communication terminal 10 transmits the reverse link data by using the carrier #2. Here, the power control information is the information generated by the radio base station 100b on the basis of the reception quality of the reverse link data to be transmitted by the carrier #2.

In step 17, the radio communication terminal 10 adjusts the transmission power of the reverse link data to be transmitted by using the carrier #2 through the closed loop control. Specifically, the radio communication terminal 10 adjusts the transmission power of the reverse link data determined in step 13 on the basis of the power control information received in step 16.

That is, the radio communication terminal 10 transmits the reverse link data by using the carrier #2 at the transmission power determined by the open loop control and the closed loop control.

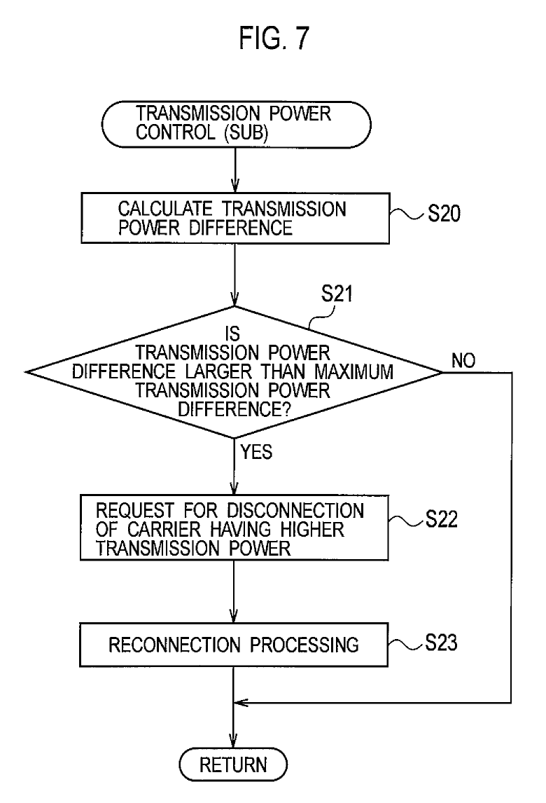

Next, sub-processing (1) of controlling transmission power will be described with reference to FIG. 7. Note that the sub-processing (1) of controlling transmission power interrupts the main processing of controlling transmission power in a predetermined cycle.

As shown in FIG. 7, in step 20, the radio communication terminal 10 calculates a difference in the transmission power (the transmission power difference) of the reverse link data between the adjacent carriers (the carrier #1 and the carrier #2).

In step 21, the radio communication terminal 10 determines whether or not the transmission power difference between the adjacent carriers exceeds the threshold that is set up on the basis of the maximum transmission power difference (MaxRLTxPwrDiff). The radio communication terminal 10 proceeds to the processing in step 22 when the transmission power difference between the adjacent carriers exceeds the threshold set up on the basis of the maximum transmission power difference. Meanwhile, when the transmission power difference between the adjacent carriers does not exceed the threshold set up on the basis of the maximum transmission power difference, the radio communication terminal 10 terminates the sub-processing of controlling transmission power.

Here, as described previously, the threshold to be set up on the basis of the maximum transmission power difference may be equal to the maximum transmission power difference or may be a value smaller than the maximum transmission power difference (such as a value obtained by multiplying the maximum transmission power difference by a predetermined ratio (0.9)).

In step 22, the radio communication terminal 10 transmits a disconnection request for the carrier having higher transmission power to the radio base station 100 to which the carrier having higher transmission power out of the adjacent carriers is connected.

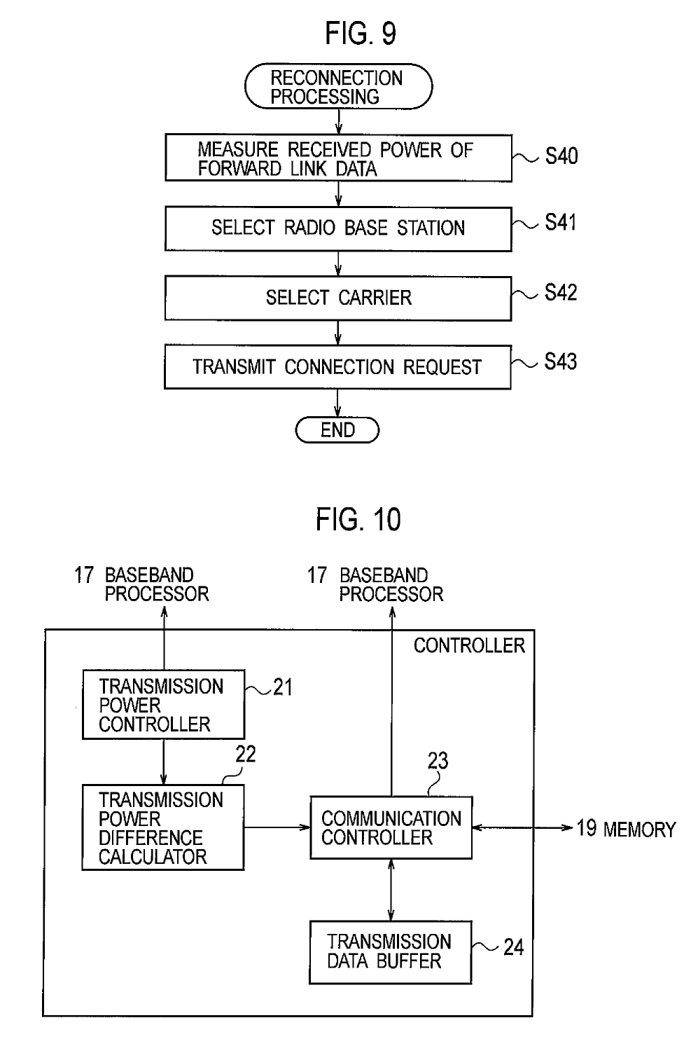

In step 23, the radio communication terminal 10 executes processing for connecting a new carrier (reconnection processing) in order to supplement a reverse link data transmission capacity which is decreased by disconnecting the carrier. Details of the reconnection processing will be described later (see FIG. 9).

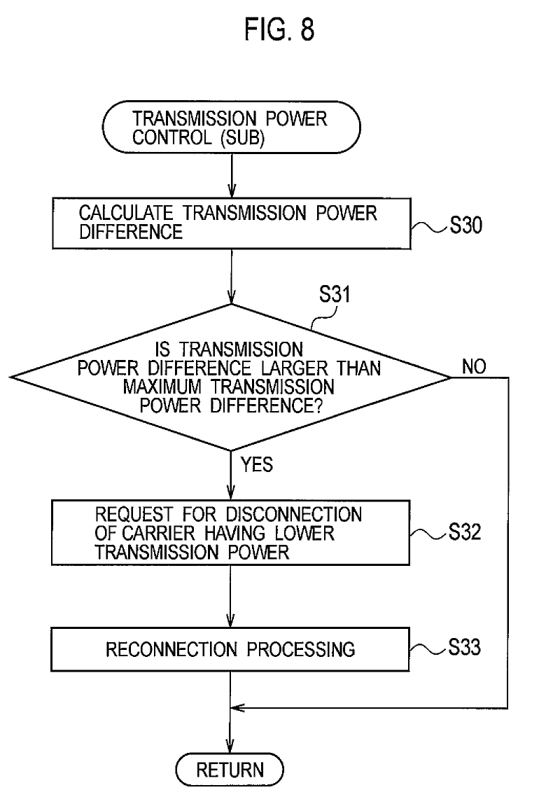

Next, sub-processing (2) of controlling transmission power will be described with reference to FIG. 8. Note that the sub-processing (2) of controlling transmission power interrupts the main processing of controlling transmission power in a predetermined cycle as similar to the sub-processing (1) of controlling transmission power.

As shown in FIG. 8, in step 30, the radio communication terminal 10 calculates a difference in the transmission power (the transmission power difference) of the reverse link data between the adjacent carriers (the carrier #1 and the carrier #2).

In step 31, the radio communication terminal 10 determines whether or not the transmission power difference between the adjacent carriers exceeds the threshold that is set up on the basis of the maximum transmission power difference (MaxRLTxPwrDiff). The radio communication terminal 10 proceeds to the processing in step 32 when the transmission power difference between the adjacent carriers exceeds the threshold set up on the basis of the maximum transmission power difference. Meanwhile, when the transmission power difference between the adjacent carriers does not exceed the threshold set up on the basis of the maximum transmission power difference, the radio communication terminal 10 terminates the sub-processing of controlling transmission power.

Here, as described previously, the threshold to be set up on the basis of the maximum transmission power difference may be equal to the maximum transmission power difference or may be a value smaller than the maximum transmission power difference (such as a value obtained by multiplying the maximum transmission power difference by a predetermined ratio (0.9)).

In step 32, the radio communication terminal 10 transmits a disconnection request for the carrier having lower transmission power to the radio base station 100 to which the carrier having lower transmission power out of the adjacent carriers is connected.

In step 33, the radio communication terminal 10 executes the processing for connecting a new carrier (the reconnection processing) in order to supplement the reverse link data transmission capacity which is decreased by disconnecting the carrier. Details of the reconnection processing will be described later (see FIG. 9).

Lastly, the details of the reconnection processing shown in FIG. 7 and FIG. 8 will be described with reference to FIG. 9.

As shown in FIG. 9, in step 40, the radio communication terminal 10 measures reception quality (SIR, for example) of the forward link data which is transmitted by the radio base stations 100 located around the radio communication terminal 10.

In step 41, the radio communication terminal 10 selects the radio base station 100 to be connected to the radio communication terminal 10 on the basis of the reception quality measured in step 40. For example, the radio communication terminal 10 selects the radio base station 100 that has transmitted the forward link data having the best reception quality measured in step 40 as the radio base station 100 to be connected to the radio communication terminal 10.

Here, the radio communication terminal 10 refers to the table stored in the memory 19 and excludes the radio base station 100 the “connection status” column of which is marked as “disconnected” from the radio base station 100 to be connected to the radio communication terminal 10.

In step 42, the radio communication terminal 10 refers to the table stored in the memory 19 and selects the carrier to be used for transmission of the reverse link data out of the carriers the “connection status” columns of which are marked either as “unused” or “disconnected”. For example, the radio communication terminal 10 selects the carrier having the central frequency that is the farthest from the central frequency of the carrier thereof from the carriers the “connection status” columns of which are marked as “connected”.

In step 43, the radio communication terminal 10 transmits a connection request for requesting connection to the carrier selected in step 42 to the radio base station 100 that is selected in step 41.

(Action and Effect)

According to the radio communication terminal 10 of the first embodiment of the present invention, when the transmission power difference between the adjacent carriers exceeds the threshold set up on the basis of the maximum transmission power difference (MaxRLTxPwrDiff), by transmitting the disconnection request for any one carrier out of the adjacent carriers, the communication controller 23 disconnects the connection to the radio base station 100 via the carrier. Hence it is possible to suppress the transmission power difference from exceeding the maximum transmission power difference.

In other words, it is possible to continue communications by multicarrier while suppressing interference between the adjacent carriers which are adjacent to each other while having the predetermined frequency interval.

Moreover, according to the radio communication terminal 10 of the first embodiment of the present invention, the communication controller 23 executes the reconnection processing of the new carrier after disconnecting any one carrier out of the adjacent carriers. Hence it is possible to supplement reverse link data transmission capacity which is decreased by disconnecting the carrier.

In this case, the communication controller 23 refers to the table stored in the memory 19 and excludes the radio base station 100 the “connection status column” of which is marked as “disconnected” from the radio base station 100 to be connected to the radio communication terminal 10. Hence it is possible to reduce a possibility that the transmission power difference exceeds the threshold set up on the basis of the maximum transmission power difference in the case of connection to the radio base station 100 via the new carrier.

### Second Embodiment

A second embodiment of the present invention will be described hereinafter. In the following, differences between the first embodiment described above and the second embodiment will be mainly described.

Specifically, in the above-described first embodiment, the radio communication terminal 10 executes the reconnection processing of the carrier immediately after disconnecting any one carrier out of the adjacent carriers.

On the other hand, in the second embodiment, the radio communication terminal 10 determines whether or not a retention amount of the reverse link data to be transmitted exceeds a predetermined threshold (an allowable retention amount) after disconnecting any one carrier out of the adjacent carriers. Subsequently, the radio communication terminal 10 executes reconnection processing of a carrier when the retention amount of the reverse link data to be transmitted exceeds the predetermined threshold.

(Configuration of Radio Communication Terminal)

A configuration of the radio communication terminal according to the second embodiment of the present invention will be described hereinafter with reference to the drawings. FIG. 10 is a functional block configuration diagram showing a configuration of the controller 20 of the radio communication terminal 10 according to the second embodiment of the present invention. It should be noted that in FIG. 10, similar reference numerals are assigned to the configuration similar to FIG. 5.

As shown in FIG. 10, the controller 20 includes a transmission data buffer 24 in addition to the transmission power controller 21, the transmission power difference calculator 22, and the communication controller 23.

The transmission data buffer 24 is the buffer for temporarily storing therein reverse link data to be transmitted (transmission data). Here, the reverse link data stored in the transmission data buffer 24 (the transmission data) is transmitted by use of the carrier the “connection status” column of which is marked as “connected” in the table stored in the memory 19.

Moreover, the transmission data buffer 24 includes a setting of a maximum allowable retention amount which is a reverse link data amount allowed to be retained in the transmission data buffer 24, and a predetermined threshold (an allowable retention amount) is set to the maximum allowable retention amount or less. Here, the maximum allowable retention amount is determined depending on a maximum delay amount allowed to a reverse link signal, for example. Meanwhile, the maximum delay amount is determined depending on the application type (a voice or an image, for example).

When disconnecting any one carrier out of the adjacent carriers, the communication controller 23 determines whether or not the reverse link data (the transmission data) stored in the transmission data buffer 24 exceeds the predetermined threshold (the allowable retention amount).

Subsequently, when the reverse link data (the transmission data) exceeds the predetermined threshold, the communication controller 23 selects the radio base station 100 to be connected to the radio communication terminal 10 out of the radio base stations 100 located around the radio communication terminal 10, and selects the carrier to be used for transmission of the reverse link data.

(Operation of Radio Communication Terminal)

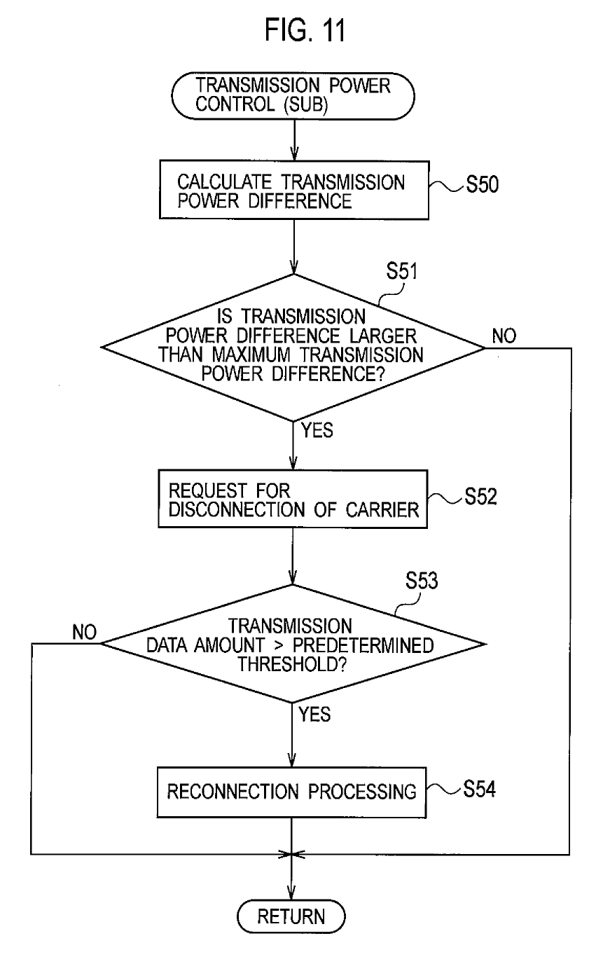

The operation of the radio communication terminal according to the second embodiment of the present invention will be described below with reference to the drawings. FIG. 11 is a flowchart showing an operation of the controller 20 of the radio communication terminal 10 according to the second embodiment of the present invention. Note that sub-processing of controlling transmission power shown in FIG. 11 is executed instead of the above-described sub-processing of controlling transmission power shown in FIG. 7 and FIG. 8.

As shown in FIG. 11, in step 50, the radio communication terminal 10 calculates a difference in the transmission power (the transmission power difference) of the reverse link data between the adjacent carriers (the carrier #1 and the carrier #2).

In step 51, the radio communication terminal 10 determines whether or not the transmission power difference between the adjacent carriers exceeds a threshold that is set up on the basis of the maximum transmission power difference (MaxRLTxPwrDiff). The radio communication terminal 10 proceeds to the processing in step 52 when the transmission power difference between the adjacent carriers exceeds the threshold set up on the basis of the maximum transmission power difference. Meanwhile, when the transmission power difference between the adjacent carriers does not exceed the threshold set up on the basis of the maximum transmission power difference, the radio communication terminal 10 terminates the sub-processing of controlling transmission power.

In step 52, the radio communication terminal 10 transmits, to the radio base station 100 to which any of the adjacent carriers is connected, a disconnection request for the carrier.

In step 53, the radio communication terminal 10 determines whether or not reverse link data (transmission data) stored in the transmission data buffer 24 exceeds the predetermined threshold (the allowable retention amount). The radio communication terminal 10 proceeds to the processing in step 54 when the reverse link data (the transmission data) exceeds the predetermined threshold. Meanwhile, when the reverse link data (the transmission data) does not exceed the predetermined threshold (the allowable retention amount), the radio communication terminal 10 terminates the transmission power control (sub).

In step 54, the radio communication terminal 10 executes processing for connecting a new carrier (reconnection processing) in order to supplement the reverse link data transmission capacity which is decreased by disconnecting the carrier. Note that the reconnection processing is similar to the above-described processing shown in FIG. 9.

(Action and Effect)

According to the radio communication terminal 10 of the second embodiment of the present invention, the communication controller 23 performs the reconnection processing of the carrier when the reverse link data (the transmission data) stored in the transmission data buffer 24 exceeds the predetermined threshold (the allowable retention amount). Specifically, the communication controller 23 determines that the transmission capacity of the reverse link data is sufficiently ensured by the carrier currently being connected when the reverse link data (the transmission data) stored in the transmission data buffer 24 does not exceed the predetermined threshold (the allowable retention amount), and therefore does not perform the reconnection processing of the carrier.

Accordingly, it is possible to make effective use of network resources by preventing unnecessary execution of the reconnection processing of the carrier.

### Third Embodiment

A third embodiment of the present invention will be described hereinafter. In the following, differences between the first embodiment described above and the third embodiment will be mainly described.

Specifically, in the above-described first embodiment, the radio communication terminal 10 disconnects any one carrier out of the adjacent carriers and performs the reconnection processing of a carrier when the transmission power difference between the adjacent carriers exceeds the threshold which is set up on the basis of the maximum transmission power difference.

On the other hand, in the third embodiment, the radio communication terminal 10 determines whether or not the transmission power difference between the adjacent carriers has increased. Then, the radio communication terminal 10 disconnects any one carrier out of the adjacent carriers and performs the reconnection processing of a carrier when the transmission power difference between the adjacent carriers has increased and the transmission power difference between the adjacent carriers exceeds the threshold set up on the basis of the maximum transmission power difference.

(Configuration of Radio Communication Terminal)

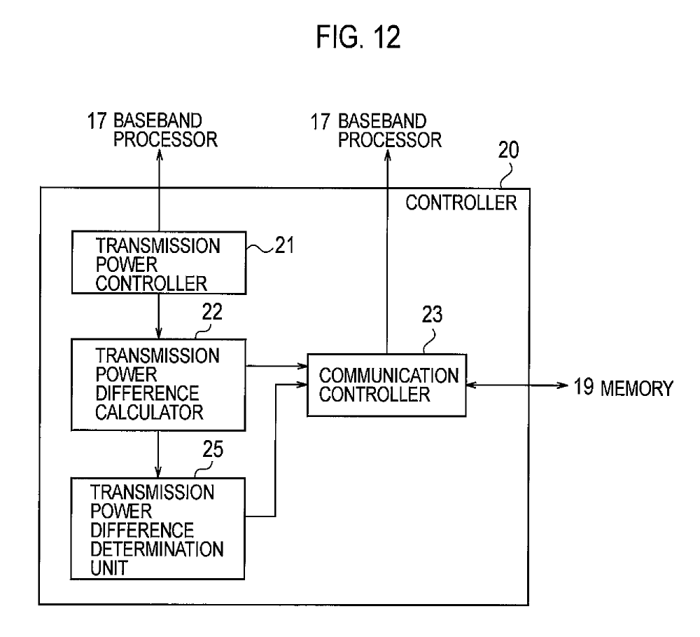

A configuration of the radio communication terminal according to the third embodiment of the present invention will be described hereinafter with reference to the drawings. FIG. 12 is a functional block configuration diagram showing the controller 20 of the radio communication terminal 10 according to the third embodiment of the present invention. It should be noted that in FIG. 12, similar reference numerals are assigned to the configuration similar to FIG. 5.

As shown in FIG. 12, the radio communication terminal 10 includes a transmission power difference determination unit 25, in addition to the transmission power controller 21, the transmission power difference calculator 22, and the communication controller 23.

The transmission power difference calculator 22 calculates a transmission power difference between adjacent carriers for each predetermined cycle (cycle in which the transmission power controller 21 performs transmission power control, for example).

The transmission power difference determination unit 25 determines whether or not the transmission power difference between the adjacent carriers has increased, the difference calculated by the transmission power difference calculator 22 for each predetermined cycle. Specifically, on the basis of the transmission power of the reverse link data, the transmission power difference determination unit 25 calculates an expression of an estimated curve (hereinafter referred to as an estimated curve expression) for each adjacent carrier, the estimated curve expression showing a situation where transmission power of the reverse link data changes on the time axis. Subsequently, the transmission power difference determination unit 25 determines whether or not a difference in values calculated by each of the estimated curve expressions (hereinafter referred to as an estimated curve difference) at a predetermined time exceeds an estimated curve difference threshold over a predetermined period. When the estimated curve difference between the adjacent carriers exceeds the estimated curve threshold over the predetermined period, the transmission power difference determination unit 25 informs the communication controller 23 of the fact that the estimated curve difference between the adjacent carriers exceeds the estimated curve threshold over the predetermined period.

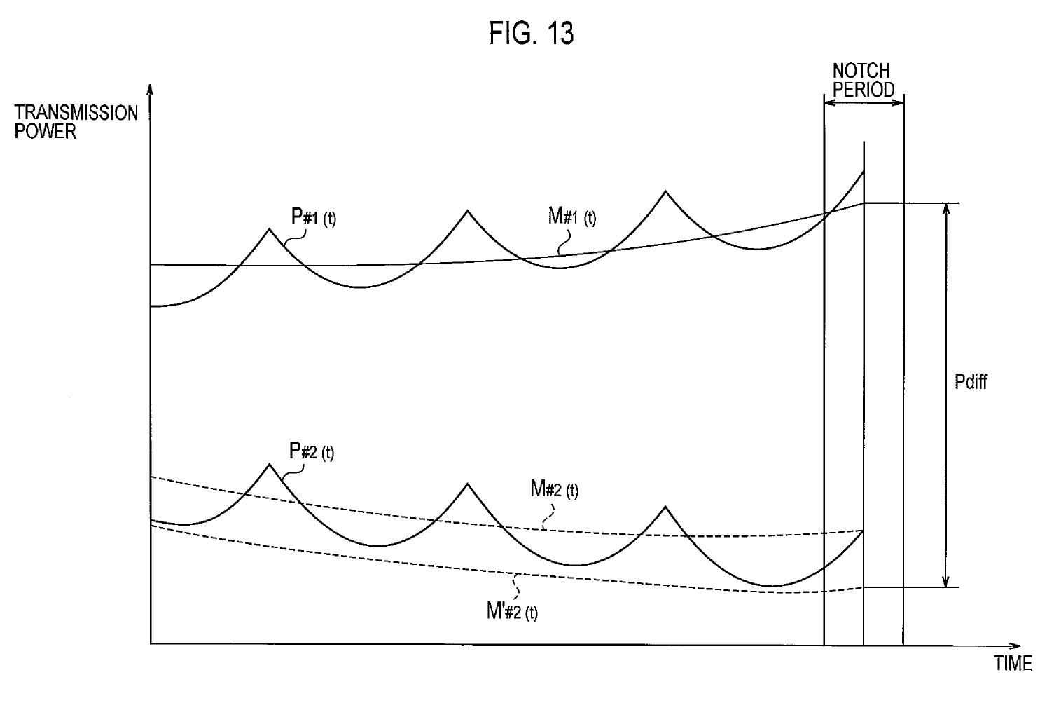

For example, using the case where adjacent carriers are a carrier #1 and a carrier #2 as an example, the procedure for calculating an estimated curve difference between the carrier #1 and the carrier #2 will be described with reference to FIG. 13. Hereinafter, considered is the case where transmission power of the carrier #1 is larger than that of the carrier #2.

Here, a notch period is determined by notch intervals calculated on the basis of reception strength and reception quality (SIR). Specifically, the notch period includes a notch interval before a peak point of a transmission power estimated curve and a notch interval after the peak point. Here, when the estimated curve difference between the adjacent carriers exceeds the estimated curve threshold throughout a predetermined period in the notch period, the radio communication terminal 10 disconnects any one carrier out of the adjacent carriers.

Specifically, when the transmission power of the carrier #1 at time t is set as “P_{#1}(t)”, an estimated curve expression “M_{#1}(t)” of the carrier #1 is calculated by the following expression (1) where α is a coefficient corresponding to the carrier #1:

[Formula 1]

M_{#1}(t)=α×P_{#1}(t)+(1−α)×M_{#1}(t−Δ6) Expression (1).

On the other hand, when the transmission power of the carrier #2 at the time t is set as “P_{#2}(t)”, an estimated curve expression “M_{#2}(t)” of the carrier #2 is calculated by the following expression (2) where β is a coefficient corresponding to the carrier #2:

[Formula 2]

M_{#2}(t)=β×P_{#2}(t)+(1−β)×M_{#2}(t−Δt) Expression (2).

Furthermore, for the carrier #2 having lower transmission power, a lower estimated curve “M′_{#2}(t)” of the carrier #2 is calculated by the following expression (3):

[Formula 3]

M′_{#2}(t)=M_{#2}(t)−max{M_{#2}(t+Δt)−P_{#2}(t+Δt)}. Expression (3).

In addition, at the time t, a difference (estimated curve difference “P_{diff}”) between a value calculated by the estimated curve expression of the carrier #1 and a value calculated by the lower estimated curve expression of the carrier #2 is calculated by the following expression (4):

[Formula 4]

P_{diff}=M_{#1}(t)−M′_{#2}(t) Expression (4).

Subsequently, the transmission power difference determination unit 25 determines whether or not the estimated curve difference “P_{diff}” calculated by the expression (1) to the expression (4) exceeds the estimated curve difference threshold (Pₜₕᵣₑₛₕ) for a predetermined period.

It is needless to say that an estimated curve difference “P_{diff}” may simply be a difference between a value calculated by the estimated curve expression “M_{#1}(t)” and a value calculated by the estimated curve expression “M_{#2}(t)”, not a difference between the value calculated by the estimated curve expression “M_{#1}(t)” and a value calculated by the lower estimated curve expression “M′_{#2}(t)”.

Here, the transmission power difference determination unit 25 may determine whether or not the estimated curve difference “P_{diff}” exceeds the estimated curve difference threshold (Pₜₕᵣₑₛₕ) in the notch period.

When the tact that the estimated curve difference between the adjacent carriers exceeds the estimated curve threshold throughout the predetermined period and the fact that the transmission power difference between the adjacent carriers exceeds the threshold set up on the basis of the maximum transmission power difference are informed, the communication controller 23 disconnects any one carrier out of the adjacent carriers and executes the reconnection processing of a carrier.

(Operation of Radio Communication Terminal)

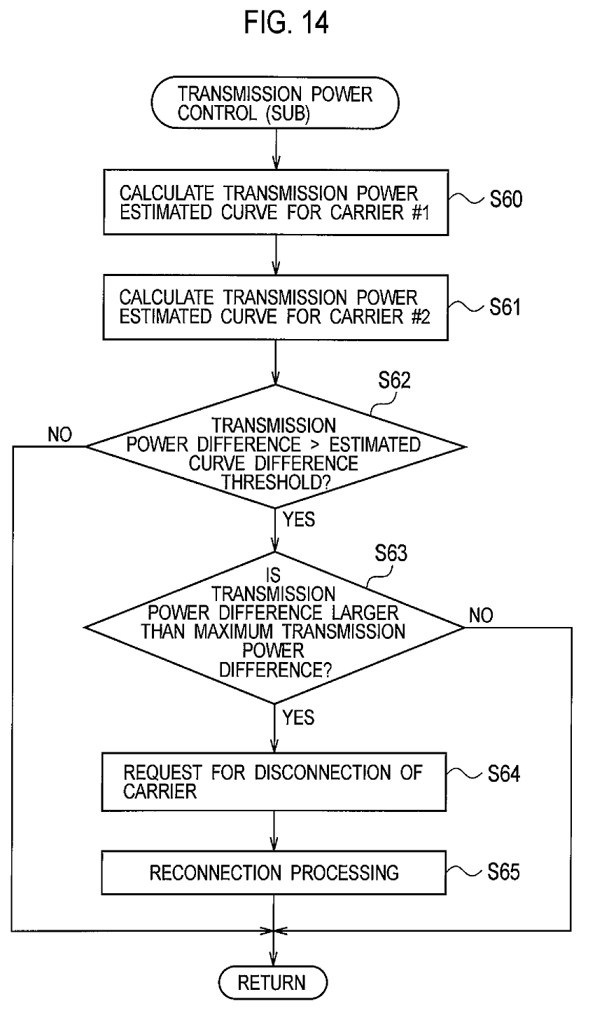

The operation of the radio communication terminal according to the third embodiment of the present invention will be described hereinafter with reference to the drawings. FIG. 14 is a flowchart of the operation of the radio communication terminal 10 according to the third embodiment of the present invention. Sub-processing of controlling transmission power shown in FIG. 14 is performed instead of the sub-processing of controlling transmission power shown in FIG. 7 and FIG. 8 as described above.

Hereinafter, as is the case of the first embodiment as described above, the case where adjacent carriers are a carrier #1 and a carrier #2 will be described as an example. In addition, the radio communication terminal 10 is assumed to transmit reverse link data to the radio base station 100a by using the carrier #1 and transmit reverse link data to the radio base station 100b by using the carrier #2. Furthermore, transmission power of the carrier #1 is assumed to be larger than that of the carrier #2.

As shown in FIG. 14, in step 60, the radio communication terminal 10 calculates an estimated curve expression of the carrier #1 on the basis of the transmission power of the reverse link data to be transmitted via the carrier #1 having higher transmission power.

In step 61, the radio communication terminal 10 calculates an estimated curve expression (or a lower estimated curve expression) of the carrier #2 on the basis of the transmission power of the reverse link data to be transmitted via the carrier #2 having lower transmission power.

In step 62, the radio communication terminal 10 determines whether or not the transmission power difference between the carrier #1 and the carrier #2 exceeds the estimated curve difference threshold on the basis of the estimated curve expression of the carrier #1 calculated in step 60 and the estimated curve expression (or the lower estimated curve expression) of the carrier #2 calculated in step 61. Specifically, the radio communication terminal 10 calculates a difference (the estimated curve difference) between a value calculated by the estimated curve expression of the carrier #1 and a value calculated by the estimated curve expression (or the lower estimated curve expression) of the carrier #2. Subsequently, the radio communication terminal 10 determines whether or not the estimated curve difference exceeds the estimated curve difference threshold throughout the predetermined period.

The radio communication terminal 10 proceeds to the processing in step 63 when the estimated curve difference exceeds the estimated curve difference threshold throughout the predetermined period. Meanwhile, when the estimated curve difference does not exceed the estimated curve difference threshold throughout the predetermined period, the radio communication terminal 10 terminates the sub-processing of controlling transmission power.

In step 63, the radio communication terminal 10 determines whether or not the transmission power difference between the carrier #1 and the carrier #2 exceeds the threshold set up on the basis of the maximum transmission power difference. The radio communication terminal 10 proceeds to the processing in step 64 when the transmission power difference exceeds the threshold set up on the basis of the maximum transmission power difference. Meanwhile, when the transmission power difference does not exceed the threshold set up on the basis of the maximum transmission power difference, the radio communication terminal 10 terminates the sub-processing of controlling transmission power.

In step 64, the radio communication terminal 10 transmits, to the radio base station 100 to which any one carrier out of the adjacent carriers is connected, a disconnection request for the carrier.

In step 65, the radio communication terminal 10 executes the processing for connecting a new carrier (the reconnection processing) in order to supplement the reverse link data transmission capacity which is decreased by disconnecting the carrier. Note that the reconnection processing is similar to the above-described processing shown in FIG. 9.

(Action and Effect)

According to the radio communication terminal 10 of the third embodiment of the present invention, not merely when the transmission power difference between the adjacent carriers exceeds the threshold set up on the basis of the maximum transmission power difference, but when the estimated curve difference between the adjacent carriers exceeds the estimated curve difference threshold throughout the predetermined period and when the transmission power difference between the adjacent carriers exceeds the threshold set up on the basis of the maximum transmission power difference, the communication controller 23 performs the disconnection processing of the carrier and the reconnection processing of a carrier.

Here, there may be a case where the transmission power of the carrier temporarily increases due to the open loop control or the closed loop control in association with deterioration in the reception quality influenced by fading or the like, for example. In such a case, even if the transmission power difference between the adjacent carriers temporarily exceeds the threshold set up on the basis of the maximum transmission power difference, it is highly likely that the transmission power difference between the adjacent carriers will fall within the maximum transmission power difference as long as the influence by facing or the like disappears.

In the third embodiment of the present invention, when the transmission power difference between the adjacent carriers temporarily exceeds the threshold set up on the basis of the maximum transmission power difference as described above, it is possible to prevent unnecessary execution of the disconnection processing of the carrier and the reconnection processing of a carrier.

### OTHER EMBODIMENTS

As described above, content of the present invention has been disclosed through one embodiment of the present invention. However, it should not be construed that the description and drawings constituting a part of this disclosure limit the present invention. Various alternative embodiments will be apparent to those skilled in the art from this disclosure.

For example, in the first embodiment to the third embodiment described above, any one carrier out of the adjacent carriers is disconnected on the basis of the fact as to whether or not the transmission power difference between the adjacent carriers exceeds the threshold set up on the basis of the maximum transmission power difference. However, the present invention shall not be limited to this.

Specifically, any one carrier out of the adjacent carriers may be disconnected on the basis of the fact as to whether or not a transmission power difference between two carriers not being adjacent to each other exceeds a predetermined threshold.

In this case, a predetermined threshold is defined in accordance with the distance between center frequencies of the two carriers being apart from each other. Specifically, as the center frequencies of the two carries are apart from each other farther, the two carriers interfere with each other to a lower extent. Thus, the predetermined threshold is defined at a low value.

In addition, the operation of the radio communication terminal 10 according to the first to third embodiments as described above can be provided as an executable program in a computer.

In this way, it is needless to say that the present invention contains various embodiments that have not been described herein. Thus, a technical scope of the present invention shall be defined only by specific matters of the invention according to the scope of the claims that are reasonable from the above description.

The content of Japanese Patent Application No. 2006-207237 (filed on Jul. 28, 2006) is incorporated herein by reference in its entirety.

### INDUSTRIAL APPLICABILITY

As has been described above, the radio communication method and the radio communication terminals according to the present invention can maintain communications by multicarrier while controlling interference between adjacent carries which are adjacent to each other with a predetermined frequency interval. Accordingly, they are useful in radio communications such as mobile communications.

1. A radio communication method in reverse link by multicarrier using at least a first carrier and a second carrier that is adjacent to the first carrier with a predetermined frequency interval, the method comprising the steps of:
calculating a transmission power difference between the first carrier and the second carrier;
determining whether or not the transmission power difference exceeds a threshold that is set up on the basis of a maximum transmission power difference allowable between the first carrier and the second carrier; and
disconnecting any one carrier out of the first carrier and the second carrier when the transmission power difference exceeds the threshold set up on the basis of the maximum transmission power difference.

2. The radio communication method according to claim 1, further comprising the step of
transmitting a connection request for requesting connection of a new carrier to a radio base station capable of communications after disconnecting any one carrier out of the first carrier and the second carrier.

3. The radio communication method according to claim 2, further comprising the step of
determining whether or not a retention amount of data to be transmitted exceeds an allowable retention amount defined to be not more than a maximum allowable retention amount of the data after disconnecting any one carrier out of the first carrier and the second carrier,
wherein in the step of transmitting the connection request, the connection request is transmitted when the retention amount of the data to be transmitted exceeds the allowable retention amount.

4. The radio communication method according to any one of claims 2 and 3,
wherein in the step of transmitting the connection request, the connection request is transmitted while excluding a radio base station, which has been connected via the carrier having been disconnected, from the radio base station capable of communications.

5. The radio communication method according to claim 1,
wherein the transmission power difference is calculated in a predetermined cycle in the step of calculating the transmission power difference,
the radio communication method further comprises the step of determining whether or not the transmission power difference has increased on the basis of the transmission power difference calculated in the predetermined cycle, and
in the step of disconnecting the carrier, any one carrier out of the first carrier and the second carrier is disconnected when the transmission power difference is determined to have increased.

6. A radio communication terminal configured to perform communications by multicarrier using at least a first carrier and a second carrier that is adjacent to the first carrier with a predetermined frequency interval, the radio communication terminal comprising:
a transmission power difference calculator configured to calculate a transmission power difference between the first carrier and the second carrier;
a transmission power difference determining unit configured to determine whether or not the transmission power difference calculated by the transmission power difference calculator exceeds a threshold that is set up on the basis of a maximum transmission power difference allowable between the first carrier and the second carrier; and
a communication controller configured to disconnect any one carrier out of the first carrier and the second carrier when the transmission power difference determining unit determines that the transmission power difference exceeds the threshold set up on the basis of the maximum transmission power difference.

7. The radio communication terminal according to claim 6, further comprising a connection request transmitter configured to transmit a connection request for requesting connection of a new carrier to a radio base station capable of communications after any one carrier out of the first carrier and the second carrier is disconnected by the communication controller.

8. The radio communication terminal according to claim 7, further comprising:
a transmission data buffer configured to accumulate data to be transmitted; and
a data retention amount determining unit configured to determine whether or not a retention amount of the data in the transmission data buffer exceeds an allowable retention amount defined to be not more than a maximum allowable retention amount after any one carrier out of the first carrier and the second carrier is disconnected by the communication controller,
wherein the connection request transmitter transmits the connection request when the data retention amount determining unit determines that the retention amount of the data exceeds the allowable retention amount.

9. The radio communication terminal according to any one of claims 7 and 8,
wherein the connection request transmitter transmits the connection request while excluding a radio base station, which has been connected via the carrier having been disconnected, from the radio base station capable of communications.

10. The radio communication terminal according to claim 6,
wherein the transmission power difference calculator calculates the transmission power difference in a predetermined cycle,
the radio communication terminal further comprises a power difference determining unit configured to determine whether or not the transmission power difference has increased on the basis of the transmission power difference calculated in the predetermined cycle by the transmission power difference calculator, and
the communication controller disconnects any one carrier out of the first carrier and the second carrier when the power difference determining unit determines that the transmission power difference has increased.
